(19) United States
(12) Patent Application Publication
(10) Pub. No.: US 2003/0233592 A1
(43) Pub. Date: Dec. 18, 2003

(54) Power saving method using frame rate control in computer graphics systems

(76) Inventors: Hung-Ming Lin, Hsinchu (TW); Kuo-Wei Yeh, Miaolo Hsien (TW)

Correspondence Address: MERCHANT & GOULD PC, P.O. BOX 2903, MINNEAPOLIS, MN, 55402-0903, US

(21) Appl. No.: 10/172,605

(22) Filed: Jun. 14, 2002

(51) Int. Cl. G06F 1/32

(52) U.S. Cl. 713/320

(57) ABSTRACT

A power saving method for computer graphics systems. First, a first time period from the start of a frame to the end of the frame is obtained. Next, the first time period is compared with a default frame time of the computer graphics system. Finally, the computer graphics system is disabled between the end of the first time period and the end of the default frame time when the first time period is shorter than the default frame time.

### BACKGROUND OF THE INVENTION

1. Field of the Invention

The present invention relates to power saving in computer graphics systems, and more particularly to a power saving method using frame rate control.

2. Description of the Related Art

CMOS is the dominant technology for modern high-performance digital circuits. Because of the growing market for battery-powered portable equipment, the drive for minimum power consumption becomes as important as the drive for increased performance. In the traditional synchronous design used for most HDL and synthesis-based designs, the system clock is connected to the clock pin on every flip-flop. This results in three major components of power consumption:

(1) Switching power (about 85%), is the power dissipated by charging and discharging the gate output capacitance and represents the useful work performed by the gate.

(2) Short-circuit power (about 15%), when the gate inputs are at an intermediate level, both the p- and n-type networks can conduct. This results in a transitory conducting path from Vdd to Vss.

(3) Leakage current (<<1%), the transistor networks conduct a very small current when they are in their off state, though in a conventional process this current is very small and generally negligible in an active current.

Clock-gating techniques are effective in reducing the total power consumption of sequential circuits. Minimizing on-chip activities can avoid clocking unnecessary circuit functions as can employment of sleep modes where possible. In FIG. 1, the clock generator 10 connected to a crystal 12 with an output enable pin can be used to prevent the circuit from being clocked until clock output is enabled. The circuit in FIG. 1 consists of a frequency generator with an output enable signal, which may be used to gate the clock until the output enable signal is assigned “true” status.

Clock scaling is another well-known technique to reduce power consumption of circuits. Dynamic clock scaling allows the clock generator to change the clock speed of the running circuit on the fly. Energy is proportional to clock frequency and proportional to the square of the operating voltage. This is a good method to save battery power, because the lower the clock speed, the less power the circuit consumes. The clock frequency can be reduced when peak performance is not required and/or power consumption is a major concern.

Low power and energy consumption will always be essential requirements in many real-time applications. For example, decoded video frames must be displayed by a certain deadline. If decoded frames are just in time to be displayed onscreen, running at a lower speed can save energy. If users cannot perceive the difference between 10 ms and 20 ms response time, the task can be run more slowly and completed in 20 ms using a slower processor frequency/voltage combination, thereby saving energy.

A graphics chip in the computer system becomes much more complex because 3D graphics acceleration is demanding. This complexity requires more transistors and higher clock speed in an integrated circuit. Therefore, power consumption in the chip becomes higher. From the foregoing, it is demanded that graphics chips be capable of supporting power saving according to application requirements.

### SUMMARY OF THE INVENTION

The object of the present invention is to provide a method to decrease the power consumption of graphics chips. Clock gating and Clock scaling techniques are employed to avoid using unnecessary power.

To achieve the above-mentioned object, the present invention provides a power saving method for computer graphics systems comprising the following steps. First, a first time period from the start of a frame to the end of the frame is obtained. Next, the first time period is compared with a default frame time of the computer graphics system. Finally, the computer graphics system is disabled between the end of the first time period and the end of the default frame time when the first time period is shorter than the default frame time.

In addition, the present invention provides a power saving method for computer graphics systems having an operating frequency, the method comprising the following steps. First, a first time period from the start of a frame to the end of the frame is obtained. Next, the first time period is compared with a default frame time of the computer graphics system. Finally, the operating frequency of the computer graphics system is decreased when the first time period is shorter than the default frame time.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a block diagram of a clock gating circuit.

FIG. 2 is a schematic block diagram illustrating the 3D-display flow.

FIG. 3 is a simplified block diagram of a conventional graphics system.

FIG. 4 is a flow chart of the computing power adjustment method according to the present invention.

FIG. 5 is a flow chart of the computing power adjustment method according to the first embodiment of the present invention.

FIG. 6 is a flow chart of the computing power adjustment method according to the second embodiment of the present invention.

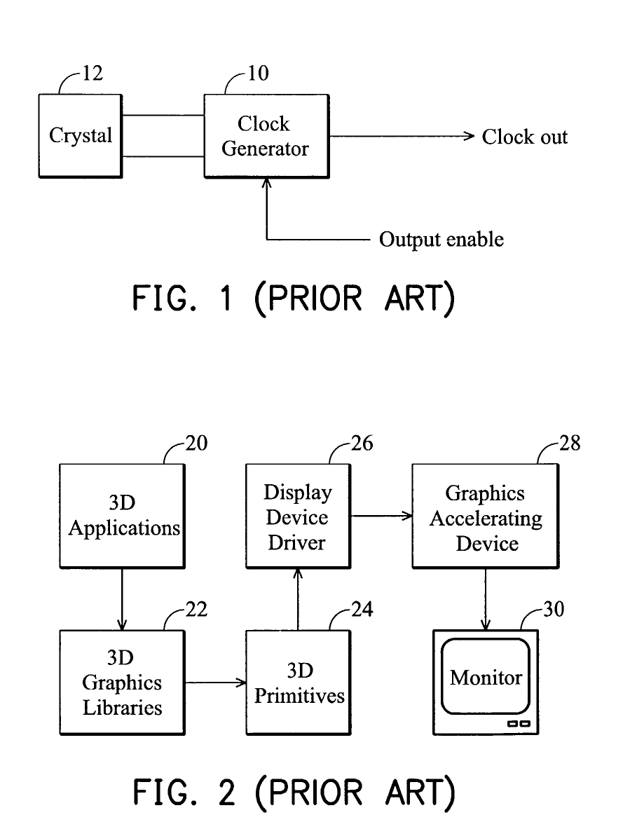

### DETAILED DESCRIPTION OF THE INVENTION

In the conventional 3D-display flow, 3D-application program 20 uses specific graphic libraries 22, such as Direct3D and OpenGL to help in designing the final 3D display. The graphics library 22 transforms 3D objects into primitives 24 accompanied by some drawing attributes. The 3D objects are transformed from world coordinates, which define the location of objects, to screen coordinates, which define the projected position on the screen. The display device driver 26 then dispatches these primitives with specific hardware commands that drive the hardware (graphics accelerating device 28) to render the desired image on screen 30 as shown in FIG. 2.

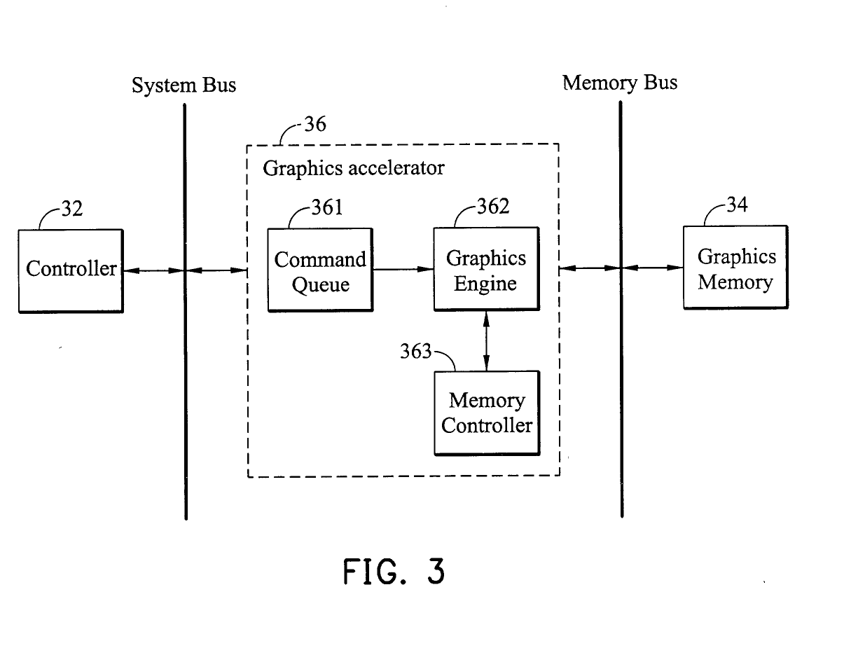

FIG. 3 shows a conventional computer graphics system. The computer graphics system includes a controller 32, a graphics memory 34 and a graphics accelerator 36, which interconnects the controller 32 and the graphics memory 34 via a system bus and a memory bus. The graphics accelerator 36 receives commands from its controller 32, executes these commands and controls the display of the image data on the display monitor. The graphics accelerator includes a hardware command queue 361, a graphics engine 362 and a memory controller 363. The hardware command queue 361 is a FIFO unit for storing command data, received from the controller 32 via the system bus. The graphics engine 362 receives and executes the commands stored in the command queue 361 and the memory controller 363 accesses the graphics memory 363 via the memory bus.

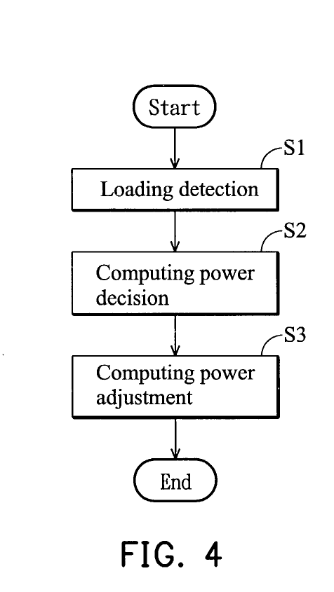

The present invention provides a method for deciding the computing power of the graphics chip according to the desired frame rate. When peak performance is not required and/or the power consumption is a major concern, the computing power can be reduced. For instance, running at 30 frames per second may be suitable for applications not requiring fast aniimation. Also, if the graphics display is not complex, there is no need to render scenes using full computing power. Based on the above, FIG. 4 is a flow chart of the computing power adjustment method according to the present invention. The desired frame rate is a predefined value. For example, 50 frames per second implies that each frame consumes 20 ms (time-per-frame).

In FIG. 4, first, load detection is performed to estimate actual rendering time of a frame (load-per-frame) (S1). The display device driver or the rendering hardware can perform the load detection. Typically, the display device driver reads the state of graphics engine and determines whether the image in the back buffer is complete (engine idle). If not, the display device driver keep trying until the graphics engine is idle. By this way, software (display device driver) can estimate the rendering time of current frame. Also, the hardware (graphics engine) can perform load detection by accumulating total time spent rendering all primitives of the current frame. Next, the computing power decision process is performed to compare the time-per-frame with load-per-frame (S2). Here, time-per-frame is set by the user or responding to the hardware limitation, and load-per-frame is the actual rendering time of a frame estimated in step S1. If the load-per-frame is less than time-per-frame, the computing power adjustment process (S3) slows the graphics engine. There are two ways to do this, clock gating or clock scaling, as described above.

First Embodiment

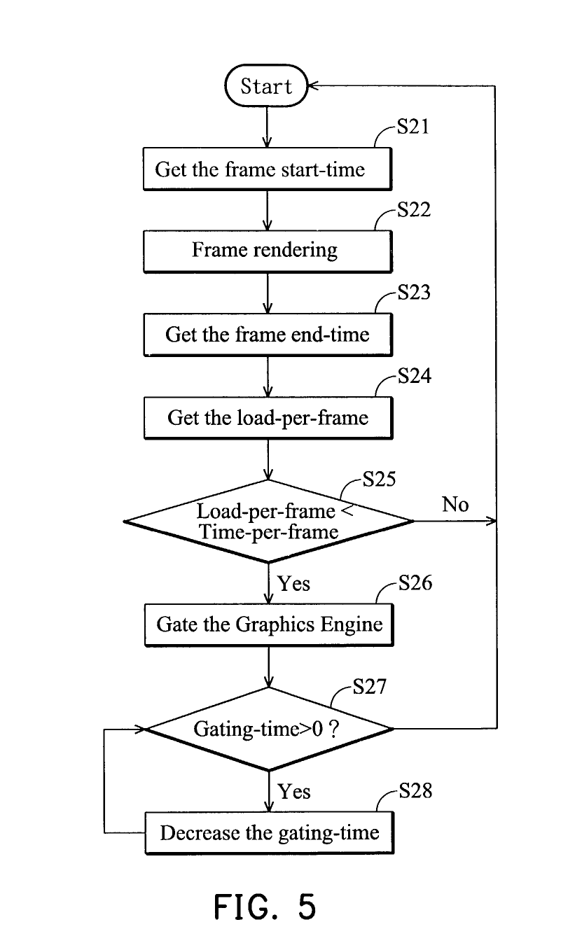

FIG. 5 is a flow chart of the computing power adjustment method according to the first embodiment of the present invention. First, the start time of a frame is obtained (S21). Then, the frame is rendered (S22). After the frame is rendered, the end time of the frame is obtained (S23). According to the start time of the frame and the end time of the frame, the load-per-frame is obtained by subtracting the start time of the frame from the end time of the frame (S24). The difference between the start-time and end-time is the load-per-frame. Next, the load-per-frame is compared to the predefined time-per-frame (S25). If load-per-frame is less than time-per-frame, the gating-time is calculated and the clock of graphics rendering engine is gated during the gating-time period (S27). Here, the gating-time period is the difference between the load-per-frame and the time-per-frame. Next, the gating-time is checked (S27). If the gating time isn't zero, the gating time keeps decreasing (S28), then the process goes back to step S27 to check the gating-time. Here, the decrease of the gating-time is a clock time of the system. If the gating time becomes zero, the process goes back to step S21 to check another frame. This forces the graphics rendering engine to enter a sleep mode to save power when the computing power of graphics rendering engine exceeds the required performance.

Second Embodiment

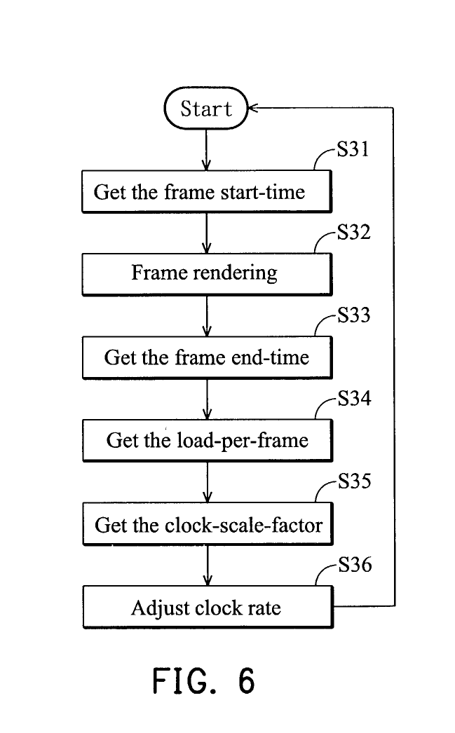

FIG. 6 is a flow chart of the computing power adjustment method according to the second embodiment of the present invention. First, the start time of a frame is obtained (S31). Then, the frame is rendered (S32). After the frame is rendered, the end time of the frame is obtained (S33). Next, the load-per-frame is obtained according the start time of the frame and the end time of the frame (S34).

The difference between FIG. 6 and FIG. 5 is the computing power adjustment process. As illustrated in FIG. 6, the clock-scale-factor is obtained by dividing load-per-frame by predefined time-per-frame (S35). The clock frequency of graphics rendering engine is obtained by multiplying current clock-frequency by clock-scale-factor (S36). If the spent rendering time of the previous frame is less than the predefined time-per-frame, the clock frequency of the graphics rendering engine will slow when rendering the next frame, otherwise, the clock frequency will be tuned up unless maximum clock frequency is reached.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A power saving method for computer graphics systems comprising the following steps:
obtaining a first time period from the start of a frame to the end of the frame;
comparing the first time period with a default frame time of the computer graphics system; and
disabling the computer graphics system from the end of the first time period to the end of the default frame time when the first time period is shorter than the default frame time.

2. The method as claimed in claim 1, wherein the first time period is the load time of the present frame.

3. The method as claimed in claim 1, wherein the default frame time is set by the user or responding to the hardware limitation.

4. The method as claimed in claim 1, wherein the computer graphics system is a graphics engine.

5. The method as claimed in claim 1, wherein the computer graphics system is disabled by Clock-gating techniques.

6. A power saving method for computer graphics systems having an operating frequency, the method comprising the following steps:
obtaining a first time period from the start of a frame to the end of the frame;
comparing the first time period with a default frame time of the computer graphics system; and
decreasing the operating frequency of the computer graphics system when the first time period is shorter than the default frame time.

7. The method as claimed in claim 6, wherein the first time period is the load time of the present frame.

8. The method as claimed in claim 6, wherein the default frame time is set by the user or responding to the hardware limitation.

9. The method as claimed in claim 6, wherein the computer graphics system is a graphics engine.

10. The method as claimed in claim 6, wherein the operating frequency of the computer graphics system is decreased by Clock scaling techniques.
